(19) United States
(12) Patent Application Publication
(10) Pub. No.: US 2021/0231436 A1
(43) Pub. Date: Jul. 29, 2021

(54) HORIZONTAL OR VERTICAL LINE TEST DEVICE AND SYSTEM

(71) Applicant: INCHEON SURVEY INSTRUMENT CO., LTD., Incheon (KR)

(72) Inventor: Seok Ki EUN, Seoul (KR)

(73) Assignee: INCHEON SURVEY INSTRUMENT CO., LTD., Incheon (KR)

(21) Appl. No.: 15/734,997

(22) PCT Filed: Mar. 14, 2019
(86) PCT No.: PCT/KR2019/002952

§ 371 Date: Dec. 4, 2020

(30) Foreign Application Priority Data
Feb. 26, 2019 (KR) 10-2019-0022731

(51) Int. Cl. G01C 9/06; G01C 25/00

(52) U.S. Cl. CPC G01C 9/06; G01C 2009/066; G01C 25/00

(57) ABSTRACT

Disclosed is a horizontal or vertical line test device for testing for an error by receiving a horizontal or vertical line laser emitted from an emitting device when a building is constructed. The horizontal or vertical line test device comprises: a reference line part which can be compared with at least one of a horizontal line laser and a vertical line laser; and a light reception part which receives at least one of an incident horizontal line laser and an incident vertical line laser.

### TECHNICAL FIELD

The following description relates to a horizontal or vertical line test device and system, and more particularly, to a horizontal or vertical line test device and system for inspecting an error caused by distortion of horizontal and vertical lines emitted from a laser emitting device.

### BACKGROUND ART

In constructing buildings, to construct such structures to be horizontal and vertical relative to the direction of gravity is one of very important conditions in terms of performance and durability of the structures.

Therefore, a work of setting accurate horizontal and vertical positions (reference lines) in space corresponds to one of important works in the fields of architecture and civil engineering.

In this manner, a scheme employed as a conventional method to set horizontal and vertical standards applied to building construction works follows a scheme of measuring the vertical accuracy or setting a vertical point by hanging a long string with a weight from the ceiling when measuring the vertical or setting a vertical point for vertical construction of a post, and measuring the horizontal or setting a horizontal point using a level aligner for horizontal construction of the floor.

The conventional vertical and horizontal setting method refers to a method of performing measurement by artificially suspending a string from the ceiling and thus, the task is difficult and dangerous. In addition, due to the string shaking, it is difficult to expect an accurate setting and it is also inconvenient since measurement needs to be performed only from top to bottom. Further, there is lack of speed and accuracy due to a work with frequently moving from place to place.

As one of the methods to outperform such issues, proposed is a laser display device. As an example of the laser display device, disclosed is a laser display device that directly displays a line on the wall at a distance by linearly emitting a laser in a horizontal and vertical direction.

A laser display device that displays lines may improve the accuracy of a work by displaying horizontal and vertical lines on the wall. Here, if distortion of an internal laser emitting portion occurs, the laser display device may not readily verify the occurrence of the distortion. To correct the distortion, there is inconvenience in that the laser display device needs to be restocked to a manufacturer.

### DISCLOSURE OF INVENTION

### Technical Subject

An aspect of an example embodiment is to provide a horizontal or vertical line test device and system that may inspect abnormality of a vertical or horizontal emitting device by detecting and comparing horizontal lines and vertical lines.

Another aspect of an example embodiment is to provide a horizontal or vertical line test device and system that allows a horizontal or vertical line test device to provide test results to a user terminal or an emitting device.

Also, another aspect is to provide a horizontal or vertical line test device and system that may automatically correct an emitting portion of an emitting device based on test results of a horizontal or vertical line test device.

Objects to be solved in example embodiments are not limited to the aforementioned objects and other objects not described herein may be clearly understood by those skilled in the art from the following description.

### Technical Solution

Disclosed is a horizontal or vertical line test device for inspecting an error by receiving a horizontal line laser or a vertical line laser emitted from an emitting device.

The horizontal or vertical line test device may include a light receiving portion provided with a reference line portion that is comparable with at least one of the horizontal line laser and the vertical line laser and configured to receive at least one of the horizontal line laser and the vertical line laser.

According to an aspect, the reference line portion may include at least one of a horizontal reference line of the horizontal line laser and a vertical reference line of the vertical line laser that is formed on the light receiving portion.

According to an aspect, the reference line portion may further include at least one pair of auxiliary lines provided to be in parallel to the horizontal reference line or the vertical reference line in both directions based on the horizontal reference line or the vertical reference line and formed to be spaced apart at a desired interval.

According to an aspect, the horizontal or vertical line test device may further include a transferring portion configured to move the light receiving portion; and a guide housing configured to guide movement of the light receiving portion.

According to an aspect, the light receiving portion may be provided with a light detection sensor configured to detect the horizontal line laser or the vertical line laser on its one surface, and the horizontal or vertical line test device may further include a controller configured to receive a signal generated by the light detection sensor and to generate a gap difference and an angle difference between a detection position of the received horizontal line laser or vertical line laser and the reference line portion as an error signal.

According to an aspect, the controller may be configured to generate horizontally or vertically based on at least one of the horizontal line laser and the vertical line laser.

According to an aspect, the horizontal or vertical line test device may further include a guide housing configured to guide movement of the light receiving portion; and a transferring portion provided to the guide housing and configured to move the light receiving portion. The controller may be configured to control the transferring portion to be moved such that at least one of the horizontal line laser and the vertical line laser corresponds to the reference line portion.

According to an aspect, the horizontal or vertical line test device may further include a display configured to quantify the error signal as a numerical value and thereby visually or auditorily display the same.

According to an aspect, the horizontal or vertical line test device may further include a transmitter configured to transmit the error signal to at least one of the emitting device and a user terminal.

A horizontal or vertical line test system according to an example embodiment is described.

The horizontal or vertical line test system may include an emitting device including at least one of a horizontal emitting portion configured to emit a horizontal line laser and a vertical emitting portion configured to emit a vertical line laser; and a horizontal or vertical line test device including a light receiving portion provided with a reference line portion that is comparable with the horizontal line laser or the vertical line laser and configured to receive at least one of the horizontal line laser and the vertical line laser and to inspect presence or absence of abnormality thereof.

According to an aspect, the light receiving portion may be provided with a light detection sensor configured to detect the horizontal line laser or the vertical line laser on its one surface, and the horizontal or vertical line test device may further include a controller configured to receive a signal generated by the light detection sensor and to generate a gap difference and an angle difference between a detection position of the received horizontal line laser or vertical line laser and the reference line portion as an error signal.

According to an aspect, the controller may be configured to generate the reference line portion horizontally or vertically based on at least one of the horizontal line laser and the vertical line laser.

According to an aspect, the horizontal or vertical line test device may further include a guide housing configured to guide movement of the light receiving portion; and a transferring portion provided to the guide housing and configured to move the light receiving portion. The controller may be configured to control the transferring portion such that at least one of the horizontal line laser and the vertical line laser corresponds to the reference line portion.

According to an aspect, the horizontal emitting portion or the vertical emitting portion may include a line laser light source configured to emit light for displaying a line; and an irradiation direction adjuster configured to adjust an irradiation angle and direction of the line laser light source.

According to an aspect, the horizontal or vertical line test device may further include a transmitter configured to transmit the error signal to at least one of the emitting device and a user terminal. The emitting device may further include a receiver configured to receive the error signal; and an irradiation direction controller configured to control the irradiation direction adjuster such that the irradiation angle and direction of the line laser light source is within the error range based on the error signal.

According to an aspect, the emitting device may further include a display configured to quantify the error signal as a numerical value and thereby visually or auditorily display the same.

### Effects

According to example embodiments, it is possible to easily inspect abnormality of a vertical or horizontal emitting device by detecting and comparing horizontal lines and vertical lines.

Also, a horizontal or vertical line test device may provide test results to a user terminal or a horizontal or vertical emitting device to be easily recognized by a user.

Also, it is possible to provide a horizontal or vertical line test device and system that may automatically correct an emitting portion of an emitting device based on test results of a horizontal or vertical line test device.

Effects of the horizontal or vertical line test device according to example embodiments are not limited to the aforementioned effects and other effects not described herein may be clearly understood by those skilled in the art from the following description.

### BRIEF DESCRIPTION OF DRAWINGS

FIG. 1 illustrates a horizontal or vertical line test system according to an example embodiment.

FIG. 2 is a perspective view illustrating an emitting device according to an example embodiment.

FIG. 3 is a perspective view illustrating a state in which a cover of an emitting device is removed according to an example embodiment.

FIG. 4 is a perspective view illustrating a horizontal or vertical line test device according to an example embodiment.

FIG. 5 is a side-cross-sectional view illustrating a horizontal or vertical line test device according to an example embodiment.

FIG. 6A illustrates a state in which a gap error of a horizontal line laser occurs when a horizontal laser is emitted toward a light receiving portion according to an example embodiment.

FIG. 6B illustrates a state in which an angle error of a horizontal line laser occurs when a horizontal laser is emitted toward a light receiving portion according to an example embodiment.

FIG. 7A illustrates a state in which a gap error of a vertical line laser occurs when the vertical line laser is emitted toward a light receiving portion according to an example embodiment.

FIG. 7B illustrates a state in which an angle error of a vertical line laser occurs when the vertical line laser is emitted toward a light receiving portion according to an example embodiment.

FIG. 8 is a block diagram illustrating a horizontal or vertical line test system according to another example embodiment.

FIG. 9A illustrates a state of generating a reference line when a horizontal laser is emitted toward a light receiving portion according to another example embodiment.

FIG. 9B illustrates a state of generating a reference line when a horizontal laser is emitted at a predetermined angle toward a light receiving portion according to another example embodiment.

The following drawings attached herein are provided as an example embodiment of the present disclosure and serve to further provide understanding of the technical spirit of the disclosure with the detailed description of the disclosure and thus, the present disclosure should not be interpreted without being limited to description illustrated in the drawings.

### BEST MODE FOR CARRYING OUT THE INVENTION

Hereinafter, example embodiments are described with reference to the accompanying drawings. In assigning reference numerals to components in the respective drawings, it should be noted that like reference numerals refer to like elements although they are illustrated in different drawings. Also, in describing example embodiments, when it is deemed detailed description related to known configuration or functions makes it difficult to understand the example embodiments, the detailed description is omitted.

Also, in describing components of example embodiments, the terms “first,” “second,” “A,” “B,” “(a),” and “(b)” may be used. Each of these terminologies is not used to define an essence, order or sequence of a corresponding component but used merely to distinguish the corresponding component from other component(s). Also, when it is described that one component is “connected,” “coupled,” or “accessed” to another component, it may be understood that the one component is directly connected or accessed to another component or that still other component is “connected,” “coupled,” or “accessed” between the two components.

A component including a common function with a component included in an example embodiment is described using the same name in another example embodiment. Unless described otherwise, description related to the example embodiment may apply to the other example embodiment and detailed description may be omitted if it is repeated.

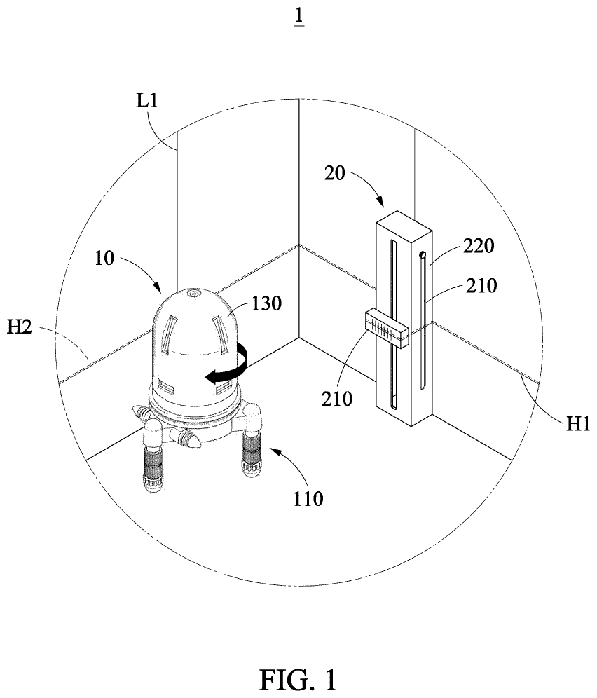

Referring to FIG. 1, a horizontal or vertical test system 1 receives a line laser (H1, H2) emitted from an emitting device 10 and inspects an error. The horizontal or vertical line test system 1 includes the emitting device 10 and a horizontal or vertical line test device 20.

Here, the horizontal or vertical line test system 1 may inspect presence or absence of abnormality by comparing a first horizontal line laser H1 emitted from a horizontal laser light source at an initial position to a reference line portion 211, 212. Also, the horizontal or vertical line test system 1 may inspect presence or absence of abnormality of a second horizontal line laser H2 emitted at the position of the initially emitted first horizontal line laser H1 by rotating a horizontal laser light source 121a present at another position through rotation of a body 120 of the emitting device 10.

Hereinafter, description is made based on an example in which the emitting device 10 emits all of the horizontal line laser (H1, H2) and a vertical line laser (V1, V2) and the horizontal or vertical line test device 20 displays all of the reference line portions 211 and 212 of the horizontal line laser (H1, H2) and the vertical line laser (V1, V2). However, it is provided as an example only for clarity of description. The emitting device 10 may emit only one of the horizontal line laser (H1, H2) and the vertical line laser (V1, V2) and the horizontal or vertical line test device 20 may include only the reference line portion 211, 212 corresponding to one of the horizontal line laser (H1, H2) and the vertical line laser (V1, V2).

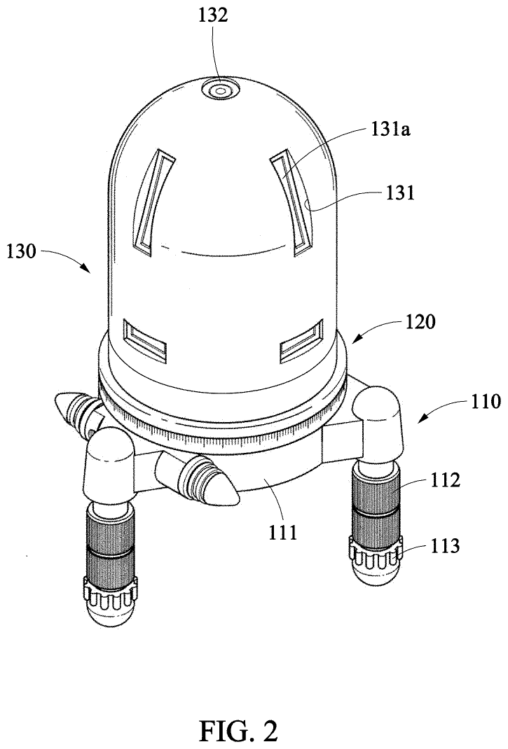

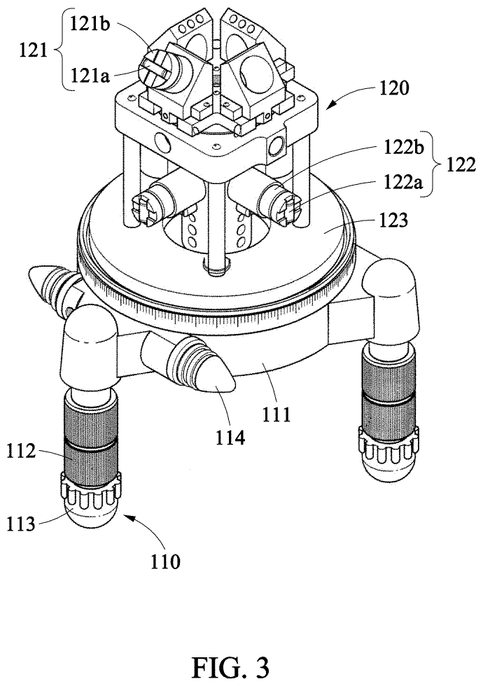

FIG. 2 is a perspective view illustrating an emitting device according to an example embodiment, and FIG. 3 is a perspective view illustrating a state in which a cover of an emitting device is removed according to an example embodiment.

The emitting device 10 may include at least one of the horizontal line laser (H1, H2) configured to display a horizontal line and the vertical line laser (V1, V2) configured to display a vertical line on the wall to be constructed. For example, the emitting device 10 may emit all of the horizontal line laser (H1, H2) and the vertical line laser (V1, V2). Also, the emitting device 10 may also display a reference point on the horizontal line laser (H1, H2) and a reference point on the vertical line laser (V1, V2).

Referring to FIGS. 2 and 3, the emitting device 10 includes a trivet 110 and the body 120.

The trivet 110 includes an upper edge portion 111 configured to receive a support portion 123, a trivet-typed leg portion 112 configured to extend downward, and an extending portion 113 configured to be extendable from a lower end of the leg portion 112. The trivet 110 may support the body 120 and may adjust the level of the body 120 through extension of the extending portion 113.

The trivet 110 may further include a fine adjuster 114. The fine adjuster 114 may be provided in a form of an internally threaded rod. As described below, when the body 120 is received, the fine adjuster 114 is engaged with gear teeth of the outer peripheral surface of a lower end of the support portion 123. The fine adjuster 114 rotates the body 120 based on an axis perpendicular to the water surface at the time of rotation. The fine adjuster 114 may be configured to be manually rotatable. However, it is provided as an example only. A motor may be provided to rotate the fine adjuster 114.

The body 120 includes an emitting portion (121, 122), the support portion 123, and a cover 130.

The emitting portion (121, 122) includes a horizontal emitting portion 121 and a vertical emitting portion 122. Each of the horizontal emitting portion 121 and the vertical emitting portion 122 divides the horizontal plane based on 360 degrees and is provided at each 90 degrees in 4 places. However, it is provided as an example only and thus, at least one horizontal emitting portion 121 and vertical emitting portion 122 may be provided. The emitting portion (121, 122) includes a line laser light source 121a, 122a configured to emit and display a vertical or horizontal line laser and an irradiation direction adjuster 121b, 122b configured to support the line laser light source 121a, 122a and to adjust an irradiation angle and direction of the line laser by adjusting rotation of a light source.

Here, the irradiation direction adjuster 121b, 122b adjusts an irradiation angle of a laser by rotating the line laser light source 121a, 122a. For example, referring to FIG. 3, the irradiation direction adjuster 121b, 122b may be provided to insert into the support portion 123 in a cylindrical shape and thereby be rotatable. In response to rotation of the irradiation direction adjuster 121b, 122b, the line laser light source 121a, 122a rotates based on an axis perpendicular to a longitudinal direction of the line laser light source 121a, 122a. Accordingly, an angle of the line laser (H1, H2, V1, V2) rotates.

The irradiation direction adjuster 121b, 122b may be fastened to enable rotation of the line laser light source 121a, 122a. The irradiation direction adjuster 121b, 122b may include a fine adjustment screw (not shown) configured to rotate the line laser light source 121a, 122a. Referring to the figures, the line laser light source 121a, 122a is provided in a cylindrical shape and emits the line laser (H1, H2, V1, V2) having a linear shape in the longitudinal direction. Here, in response to rotating the line laser light source 121a, 122a by using the longitudinal direction as an axis, the irradiation direction, that is, the vertical direction or the horizontal direction of the line laser (H1, H2, V1, V2) may move in the vertical direction or the horizontal direction.

The irradiation direction adjuster 121b, 122b may be configured to adjust the irradiation angle and direction of the line laser light source 121a, 122a by manually moving an adjustment screw or by directly turning the adjustment screw by hand. However, it is provided as an example only. The irradiation direction adjuster 121b, 122b may include a driver (not shown), such as a separate motor, configured to adjust the irradiation angle and direction of the line laser light source 121a, 122a in response to a signal of the horizontal or vertical line test device 20, which is described below.

The support portion 123 supports the irradiation direction adjuster 121b, 122b. For example, the support portion 123 is configured in a 2-floor form that includes a plurality of plates and a plurality of columns and to support the irradiation direction support portion 123 on each floor.

Bottom of the support portion 123 couples with the trivet 110. Also, the lower outer peripheral surface of the support portion 123 is formed in a gear form and configured to insert into the trivet 110 and engage with the thread of the fine adjuster 114. The support portion 123 rotates based on the axis perpendicular to the water surface in response to rotation of the fine adjuster 114.

The cover 130 protects the support portion 123 from the outside. A plurality of through-holes 131 is formed in the cover 130. The plurality of through-holes 131 is formed at positions corresponding to the line laser light sources 121a and 122a, respectively.

Meanwhile, a transparent protective window 131a may be provided to each of the plurality of through-holes 131 to protect the line laser light source 121a, 122a. Here, the protective window 131a may be detachably provided for maintenance and repair of the line laser light source 121a, 122a.

Also, a leveler 132 is provided on one side of the cover 130. For example, the leveler 132 in a circular shape may be provided on top of the cover 130. Although the example embodiment illustrates the leveler 132 as the circular leveler 132, it is provided as an example only. Any leveler 132 capable of measuring the level of the emitting device 10 may apply. In the case of adjusting the trivet 110 of the emitting device 10, the leveler 132 may indicate the level of the emitting device 10, thereby facilitating the horizontal adjustment of the emitting device 10.

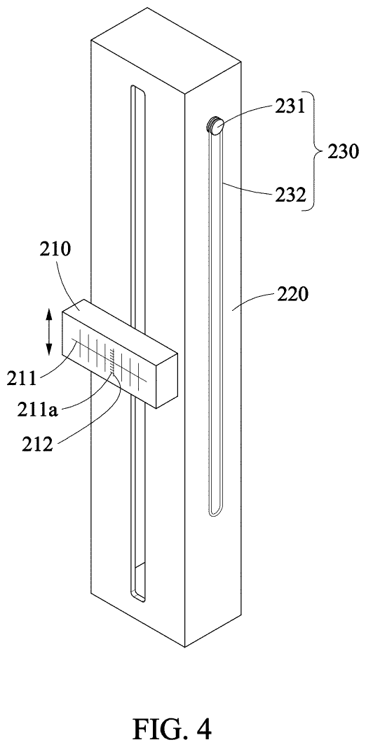

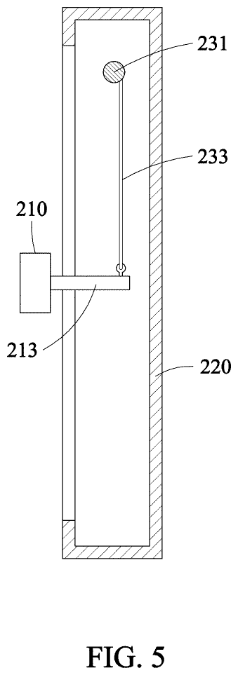

FIG. 4 is a perspective view illustrating a horizontal or vertical line test device according to an example embodiment, and FIG. 5 is a side-cross-sectional view illustrating a horizontal or vertical line test device according to an example embodiment.

Referring to FIGS. 4 and 5, the horizontal or vertical line test device 20 receives at least one of the horizontal line laser (H1, H2) and the vertical line laser (V1, V2) and inspects presence or absence of abnormality. The horizontal or vertical line test device 20 includes a light receiving portion 210, a guide housing 220, and a transferring portion 230.

The light receiving portion 210 receives at least one of the horizontal line laser (H1, H2) and the vertical line laser (V1, V2) emitted from the emitting device 10. The light receiving portion 210 may be in any shape formed with the plane through which one of the horizontal line laser (H1, H2) and vertical line laser (V1, V2) is incident.

The light receiving portion 210 may include the reference line portion 211, 212 on the surface to which the horizontal line laser (H1, H2) or vertical line laser (V1, V2) is incident. The reference line portion 211, 212 may be a line of the scale already marked on the light receiving portion 210 and may be a reference line virtually formed when the incident surface of the light receiving portion 210 is a light detection sensor 311. The reference line portion 211, 212 includes at least one of a horizontal reference line 211 of the horizontal line laser (H1, H2) and a vertical reference line 212 of the vertical line laser (V1, V2) is formed. When the horizontal or vertical line test device 20 is horizontal, the horizontal reference line 211 and the vertical reference line 212 form the horizontal and the vertical relative to the horizontal plane.

Also, the reference line portion 211, 212 may include at least one pair of auxiliary lines 211a provided to be in parallel with the horizontal reference line 211 or the vertical reference line 212 in both directions based on the horizontal reference line 211 or the vertical reference line 212 and formed to be spaced apart at a desired interval. The auxiliary lines 211a may be formed to be spaced apart based on a length unit, for example, millimeter (mm), in a form of the scale. However, it is provided as an example only. Similar to the vertical reference line 212 of FIG. 4, not the auxiliary line 211a but the horizontal reference line 211 or the vertical reference line 212 may be formed in a plural form and may perform the functionality of the auxiliary line 211a.

The light receiving portion 210 may include a fixing column 213 on the surface that faces the guide housing 220, which is described below. The fixing column 213 may insert into the guide housing 220.

Although not illustrated, a horizontal slit hole (not shown) may be further formed on the surface of the light receiving portion 210 that faces the guide housing 220 in the longitudinal direction, that is, the horizontal direction of the light receiving portion 210. The fixing column 213 may insert into the horizontal slit hole and thereby move along the horizontal slit hole. Here, a fixing member (not shown), such as a screw, may be further provided for fixing after adjusting an angle of the light receiving portion 210 by using the fixing column 213 as an axis.

The light receiving portion 210 may further include a support screw 214. The support screw 214 inserts into the light receiving portion 210 to protrude from the surface that faces the guide housing 220 of the light receiving portion 210. Since a thread is formed along the outer peripheral surface of the support screw 214, a protruding length may be adjusted on a guide housing side of the light receiving portion 210. The light receiving portion 210 may perform horizontal setting through the fixing column 213 and the support screw 214. The light receiving portion 210 may further include a leveler (not shown).

However, it is provided as an example only. The leveler may be provided to the guide housing 220. The horizontal adjustment of the light receiving portion 210 may be enabled by forming an extending leg in a trivet shape of the emitting device 10 in a lower portion of the guide housing 220.

The guide housing 220 guides movement of the light receiving portion 210. For example, the guide housing 220 may guide the vertical movement of the light receiving portion 210. Here, a slit hole 221 into which the fixing column inserts may be formed in the guide housing 220. The slit hole 221 may be elongated in the longitudinal direction, that is, the vertical direction of the guide housing 220 to guide the vertical movement of the light receiving portion 210.

Although the example embodiment illustrates that the guide housing 220 is configured to guide the vertical movement of the light receiving portion 210, it is provided as an example only. The longitudinal direction of the slit hole 221 may be configured to guide the horizontal movement of the light receiving portion 210. Here, the slit hole 221 may be formed in the vertical direction on the surface of the guide housing 220 that faces the light receiving portion 210. Meanwhile, the scale and the height may be marked at desired intervals along the slit hole 221 of the guide housing 220. In this case, the height measurement of the reference line portion 211, 212 may be smoothly performed.

The transferring portion 230 moves the light receiving portion 210 in the guide direction of the guide housing 220. For example, the transferring portion 230 may include a rotating column 231 rotatably provided to the guide housing 220, a first string 232 provided at the outside of the guide housing 220 and configured to rotate the rotating column 231, and a second string 233 configured to wind around the rotating column 231 and to couple with the fixing column 213 of the light receiving portion 210. Here, a user may move the light receiving portion 210 in the vertical direction by changing the rotational direction of the rotating column 231 through the first string 232.

However, a shape of the transferring portion 230 is not limited thereto and any type of moving the light receiving portion 210 may apply. For example, the transferring portion 230 may include a motor to adjust the rotation of the rotating column 231 through the second string 233. As another example, the transferring portion 230 may be configured to move and stop along a rail in a simple rail and brake configuration.

Also, the guide housing 220 may be provided in an elongated rod shape and the transferring portion 230 may be configured to move in the longitudinal direction of the guide housing 220 in a form of enclosing the guide housing 220. Here, the transferring portion 230 may include a fixing member (not shown), such as a screw, configured to fix the transferring portion 230 to the guide housing 220.

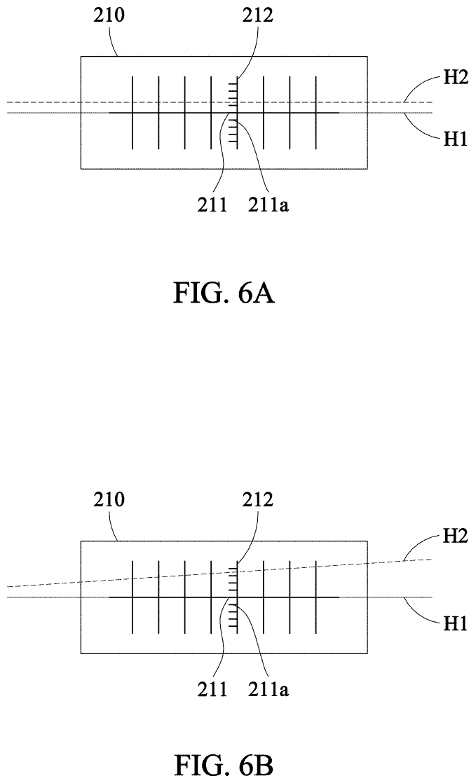

FIG. 6A illustrates a state in which a gap error of a horizontal line laser occurs when a horizontal laser is emitted toward a light receiving portion according to an example embodiment, and FIG. 6B illustrates a state in which an angle error of a horizontal line laser occurs when a horizontal laser is emitted toward a light receiving portion according to an example embodiment.

Hereinafter, an inspection method using the horizontal or vertical line test system 1 is described. The light receiving portion is moved such that the reference line portion 211, 212 may correspond to the first horizontal line laser H1 emitted from a single horizontal line laser light source 121a. Here, after horizontal and vertical adjustment of the light receiving portion 210, the reference line portion 211 is provided to correspond to the first horizontal line laser H1. Next, the second horizontal line laser H2 is emitted from another line laser light source by rotating the support portion 123 of the emitting device 10. Here, when emitting the second horizontal line laser H2, the first horizontal line laser H1 is also rotated in another direction and thus, invisible. However, since the reference line portion 211 corresponding to the first horizontal line laser H1 is suspended, presence or absence of abnormality may be inspected through comparison.

Referring to FIG. 6A, the second horizontal line laser H2 is parallel to the horizontal reference line portion 211, however, may have a gap error. Also, referring to FIG. 6B, an angle error may occur between the second horizontal line laser H2 emitted from a second line laser light source and the horizontal reference line portion 211. Here, the gap error may be corrected in such a manner that the user adjusts the irradiation direction of the line laser light source 121a. The gap error may be set within the error range of 0˜±2 mm as the range set by the user. Also, the angle error may be corrected in such a manner that the user adjusts an irradiation angle of the line laser light source.

Also, when allowing the first horizontal line laser H1 emitted from the single line laser light source 121a to correspond to the reference line portion 211, 212, an angle of the single line laser light source 121a may be distorted. In this case, the angle may be corrected by controlling the irradiation direction adjuster of the single line laser light source 121a.

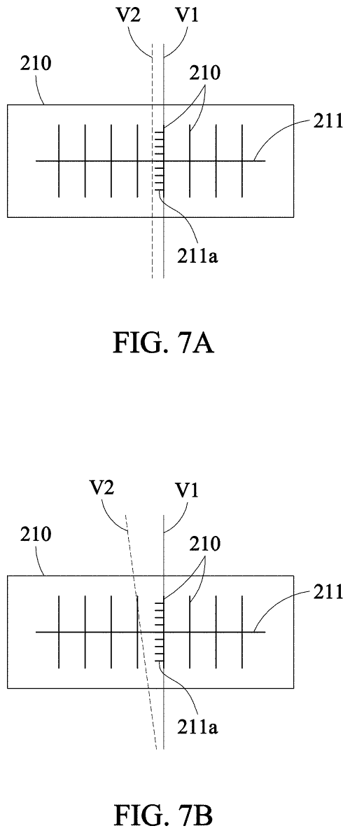

FIG. 7A illustrates a state in which a gap error of a vertical line laser occurs when the vertical line laser is emitted toward a light receiving portion according to an example embodiment, and FIG. 7B illustrates a state in which an angle error of a vertical line laser occurs when the vertical line laser is emitted toward a light receiving portion according to an example embodiment. As described above, the gap error and the angle error may be corrected by inspecting the abnormality of a first vertical laser line V1 and a second vertical laser line V2 through comparison to the vertical reference line 212 using the horizontal or vertical line test system 1.

Meanwhile, when the height of the reference line portion 211, 212 is preset, the gap error and the angle error between the first horizontal line laser (H1) or the first vertical line laser (V1) and the reference line portion 211, 212 may be corrected based on a line displayed on the horizontal or vertical line test device 20.

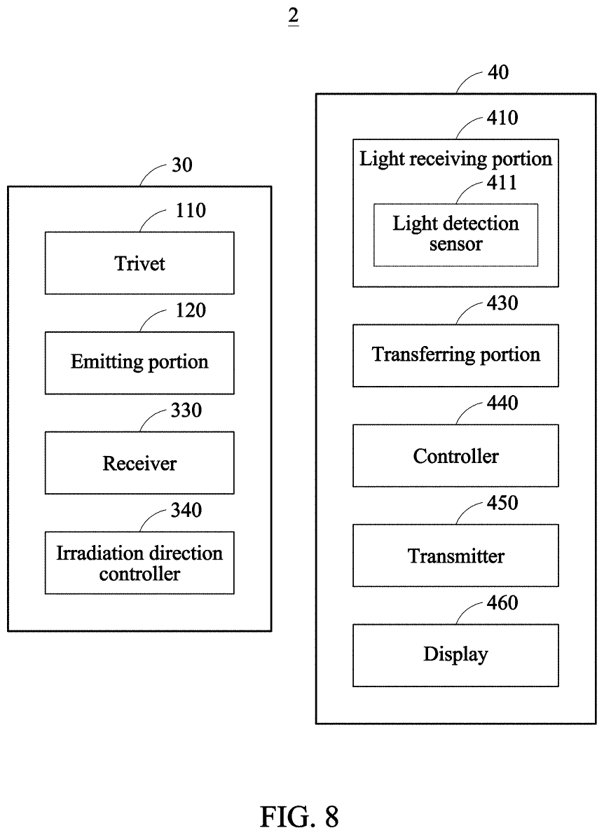

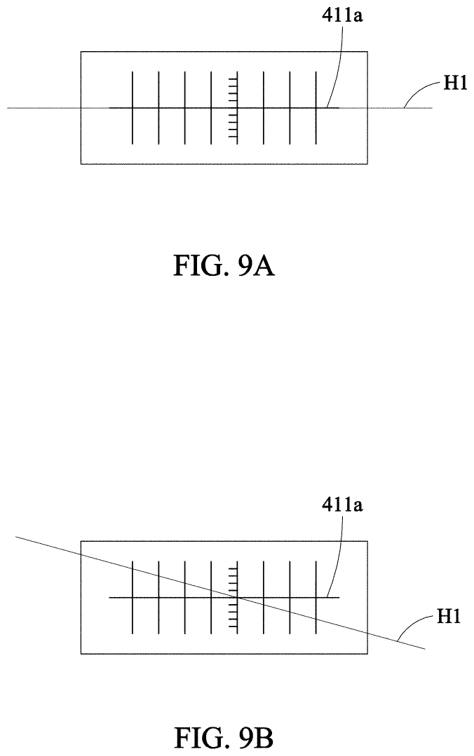

Hereinafter, a horizontal or vertical line test device and system according to another example embodiment is described with reference to FIGS. 8 and 9.

FIG. 8 is a block diagram illustrating a horizontal or vertical line test system according to another example embodiment, FIG. 9A illustrates a state of generating a reference line when a horizontal laser is emitted toward a light receiving portion according to another example embodiment, and FIG. 9B illustrates a state of generating a reference line when a horizontal laser is emitted at a predetermined angle toward a light receiving portion according to another example embodiment.

Referring to FIG. 8, a horizontal or vertical line test system 1 refers to an electronic system and is configured as a system to perform inspection and error correction of a laser line. For example, the horizontal or vertical line test system 1 may include an emitting device 30 and a horizontal or vertical line test device 40, and may be a system that allows the emitting device 10 to automatically correct the angle and irradiation direction of the line laser light source 121a, 122a when the horizontal or vertical line test device 40 generates an error signal.

The emitting device 10 includes the trivet 110, the body 120, a receiver 330, and an irradiation direction controller 340. Here, the configuration of the trivet 110 and the body 120 includes the same components as those of the emitting device 10 according to the example embodiment and thus, further description is omitted. Here, the irradiation direction adjuster 121b, 122b includes a motor and a gear to rotate the irradiation direction adjuster 121b, 122b or to rotate the line laser light source 121a, 122a.

The receiver 330 receives an error signal, which is described below. For example, the receiver 330 may be provided as one of communication modules, such as Radio Frequency (RF) communication, Wireless Fidelity (WiFi) Direct, Bluetooth, Infrared Data Association (IrDA), ZigBee, Ultra Wideband (UWB), and the like, and may be configured to receive an error signal through direct connection to the horizontal or vertical line test device 40. Alternatively, the receiver 330 may be provided as a communication module, such as Wideband Code Division Multiplex Access (WCDMA), Long Term Evolution (LTE), WiFi, and the like, and may be configured to receive an error signal through connection over an Internet network.

The irradiation direction controller 340 controls the irradiation direction adjuster 121b, 122b such that the irradiation angle and direction of the line laser light source 121a, 122a is within the error range based on the error signal. For example, the irradiation direction controller 340 controls a gap and an angle to be adjusted such that the line laser (H1, H2, V1, V2) is emitted within the error range with a reference line 411a, by analyzing the error signal, by quantifying a gap error and an angle error, and by driving the motor of the irradiation direction adjuster 121b, 122b according thereto.

The horizontal or vertical line test device 40 includes a light receiving portion 410, a transferring portion 430, a controller 440, a transmitter 450, and a display 460. The light receiving portion 410 includes a light detection sensor 311 on the surface toward which the line laser (H1, H2, V1, V2) is emitted. The light detection sensor 311 refers to a sensor configured to detect a portion toward which a laser is emitted and detects the line laser (H1, H2, V1, V2) emitted toward the surface.

The transferring portion 430 may include a motor to move the light receiving portion 410. For example, the transferring portion 430 may include the motor instead of including the first string 232.

The controller 440 generates a corresponding horizontal or vertical reference line portion based on at least one of the horizontal line laser (H1, H2) and the vertical line laser (V1, V2). For example, referring to FIG. 9A, the controller 440 may generate the reference line portion 411a that matches the line laser (H1, H2, V1, V2). Referring to FIG. 9B, if the line laser (H1, H2, V1, V2) is not horizontal, the controller 440 may generate the horizontal or vertical reference line portion 411a that intersects the line laser (H1, H2, V1, V2). The light receiving portion 410 may include a display module to visually display the reference line portion 411a.

However, it is provided as an example only. The reference line portion 411a may be provided in advance to the light receiving portion 410. In this case, the controller 440 may control the transferring portion 430 to be moved such that the line laser (H1, H2, V1, V2) may correspond to the reference line portion 411a.

The controller 440 measures a gap and an angle between the reference line portion 411a and the incident line laser (H1, H2, V1, V2) and generates an error signal using the same. The controller 440 transfers the generated error signal to the transmitter 450.

The transmitter 450 transmits the error signal to the emitting device 30 or a user terminal (not shown). For example, the transmitter 450 may be configured as the same communication module as the receiver 330 and may be paired to the emitting device 10. Also, the transmitter 450 may transmit the error signal through a server (not shown) and may transmit the error signal to the emitting device 10 or the user terminal connected to the server.

Meanwhile, the user terminal may be, for example, a smartphone, a personal digital assistant (PDA), a personal computer (PC), a laptop, a tablet PC, and the like, and may receive the error signal and may visually display the error signal. Also, the reference line portion 411a of which height and angle are changed may be set through an app (not shown) installed on the user terminal. Also, a signal of the reference line portion 411a set through the server may be transmitted to the horizontal or vertical line test device 20 and the reference line portion 411a may be set accordingly.

The display 460 receives and displays the error signal from the controller 440. The display 440 may be a display module provided to the light receiving portion 410 and may be separately provided. The display 460 may quantify the error signal as a numerical value and thereby visually or auditorily display the error signal. Also, the display 460 may display the reference line portion 411a.

While the example embodiments are described with reference to the accompanying drawings, it will be apparent to one of ordinary skill in the art that various alterations and modifications in form and details may be made in these example embodiments from the description. For example, suitable results may be achieved if the described techniques are performed in different order, and/or if components in a described architecture, device, etc., are combined in a different manner, or replaced or supplemented by other components or their equivalents.

1. A horizontal or vertical line test device for inspecting an error by receiving a horizontal line laser or a vertical line laser emitted from an emitting device, the horizontal or vertical line test device comprising:
a light receiving portion provided with a reference line portion that is comparable with at least one of the horizontal line laser and the vertical line laser and configured to receive at least one of the horizontal line laser and the vertical line laser.

2. The horizontal or vertical line test device of claim 1, wherein the reference line portion comprises at least one of a horizontal reference line of the horizontal line laser and a vertical reference line of the vertical line laser that is formed on the light receiving portion.

3. The horizontal or vertical line test device of claim 2, wherein the reference line portion further comprises:
at least one pair of auxiliary lines provided to be in parallel to the horizontal reference line or the vertical reference line in both directions based on the horizontal reference line or the vertical reference line and formed to be spaced apart at a desired interval.

4. The horizontal or vertical line test device of claim 1, further comprising:
a transferring portion configured to move the light receiving portion; and
a guide housing configured to guide movement of the light receiving portion.

5. The horizontal or vertical line test device of claim 1, wherein the light receiving portion is provided with a light detection sensor configured to detect the horizontal line laser or the vertical line laser on its one surface, and
the horizontal or vertical line test device further comprises:
a controller configured to receive a signal generated by the light detection sensor and to generate a gap difference and an angle difference between a detection position of the received horizontal line laser or vertical line laser and the reference line portion as an error signal.

6. The horizontal or vertical line test device of claim 5, wherein the controller is configured to generate horizontally or vertically based on at least one of the horizontal line laser and the vertical line laser.

7. The horizontal or vertical line test device of claim 5, further comprising:
a guide housing configured to guide movement of the light receiving portion; and
a transferring portion provided to the guide housing and configured to move the light receiving portion,
wherein the controller is configured to control the transferring portion to be moved such that at least one of the horizontal line laser and the vertical line laser corresponds to the reference line portion.

8. The horizontal or vertical line test device of claim 5, further comprising:
a display configured to quantify the error signal as a numerical value and thereby visually or auditorily display the same.

9. The horizontal or vertical line test device of claim 5, further comprising:
a transmitter configured to transmit the error signal to at least one of the emitting device and a user terminal.

10. A horizontal or vertical line test system comprising:
an emitting device comprising at least one of a horizontal emitting portion configured to emit a horizontal line laser and a vertical emitting portion configured to emit a vertical line laser; and
a horizontal or vertical line test device comprising a light receiving portion provided with a reference line portion that is comparable with the horizontal line laser or the vertical line laser and configured to receive at least one of the horizontal line laser and the vertical line laser and to inspect presence or absence of abnormality thereof.

11. The horizontal or vertical line test system of claim 10, wherein the light receiving portion is provided with a light detection sensor configured to detect the horizontal line laser or the vertical line laser on its one surface, and
the horizontal or vertical line test device further comprises:
a controller configured to receive a signal generated by the light detection sensor and to generate a gap difference and an angle difference between a detection position of the received horizontal line laser or vertical line laser and the reference line portion as an error signal.

12. The horizontal or vertical line test system of claim 11, wherein the controller is configured to generate the reference line portion horizontally or vertically based on at least one of the horizontal line laser and the vertical line laser.

13. The horizontal or vertical line test system of claim 11, wherein the horizontal or vertical line test device further comprises:
a guide housing configured to guide movement of the light receiving portion; and
a transferring portion provided to the guide housing and configured to move the light receiving portion, and
the controller is configured to control the transferring portion such that at least one of the horizontal line laser and the vertical line laser corresponds to the reference line portion.

14. The horizontal or vertical line test system of claim 11, wherein the horizontal emitting portion or the vertical emitting portion comprises:
a line laser light source configured to emit light for displaying a line; and
an irradiation direction adjuster configured to adjust an irradiation angle and direction of the line laser light source.

15. The horizontal or vertical line test system of claim 14, wherein the horizontal or vertical line test device further comprises:
a transmitter configured to transmit the error signal to at least one of the emitting device and a user terminal, and
the emitting device further comprises:
a receiver configured to receive the error signal; and
an irradiation direction controller configured to control the irradiation direction adjuster such that the irradiation angle and direction of the line laser light source is within the error range based on the error signal.

16. The horizontal or vertical line test system of claim 11, wherein the emitting device further comprises:
a display configured to quantify the error signal as a numerical value and thereby visually or auditorily display the same.
